(19) United States
(12) Patent Application Publication
(10) Pub. No.: US 2017/0112714 A1
(43) Pub. Date: Apr. 27, 2017

(54) METHOD FOR ALLEVIATING OR TREATING ANAPHYLAXIS

(71) Applicants: Sung Yeoun Hwang, Incheon (KR); Korea Bio Medical Science Institute, Seoul (KR)

(72) Inventors: Sung Yeoun HWANG, Incheon (KR); Hyung Min KIM, Seoul (KR); Hyun-Ja JEONG, Seoul (KR)

(21) Appl. No.: 14/919,843

(22) Filed: Oct. 22, 2015

(51) Int. Cl. A61H 23/02; G10D 13/02

(52) U.S. Cl. CPC A61H 23/0236; G10D 13/02

(57) ABSTRACT

A method for alleviating or treating anaphylaxis is disclosed. By allowing patient suffering from anaphylaxis to hear drumming with a buk (a Korean traditional drum), the method can be useful in replacing medicinal treatment since the method has an excellent therapeutic effect with a level similar to that when a drug is administered even without administering any drugs, by reducing various kinds of inflammatory-related factors such as HIF-1α, VEGF, inflammatory cytokines and ER-β in the brain of patient suffering from anaphylaxis.

### FIELD OF THE INVENTION

The invention relates to a method for alleviating or treating anaphylaxis.

### BACKGROUND OF THE INVENTION

Anaphylaxis is a systemic allergic reaction that is usually treated in emergency departments, it is a severe immediate-type hypersensitivity reaction characterized by life-threatening upper airway obstruction bronchospasm and hypotension. Anaphylaxis causes hypotension by inducing the release of histamine from mast cells, and severe anaphylaxis is defined when accompanied by hypoxia, hypotension, or neurologic compromise, typically manifested by collapse.

Alterations in protein expression profiles after allergen sensitization and challenge resembled those observed in hypoxia, which is an essential developmental and physiological stimulus that plays key roles in the pathophysiologies of allergy, heart disease, cancer, neuron death, cerebrovascular disease, and chronic lung disease. Hypoxia induces the transcriptions of a range of physiologically important genes including vascular endothelial growth factor (VEGF) under the mediation of hypoxia-inducible factor-1 (HIF-1). It also produces an inflammatory response characterized by increases in reactive oxygen species (ROS), venular leukocyte-endothelial adherence and emigration, and vascular permeability. The productions of histamine and inflammatory cytokines are induced by evoking HIF-1.

Estrogen has potent neuroprotective effects in animal models of brain disease or injury via various mechanisms, which include anti-inflammation, reduction of oxidative stress and excitotoxicity, anti-apoptosis, and vasodilation in the ischemic brain, and it has also been reported estrogen receptor-β (ER-β) activation in brain is associated with reduced blood brain barrier (BBB) breakdown via the inhibition of HIF-1α/VEGF signaling.

The best way to treat allergic disease is to remove exogenous antigen, but it's hard to remove it completely. Therefore medicine treatments to raise IgG level or reduce IgE in lymphocyte B of immune system or reduce histamine secretion from mast cell have been universally used. Steroids to prevent secondary infection or antibiotics are also used, but they cause side effects when discontinue medication or alleviate therapeutic intensity. Hence, a new treatment without side effect is needed.

Composition comprising the extract of complex herbs as an active ingredient for preventing and treating allergy is disclosed on a Korean patent publication No. 2015-0070515.

### SUMMARY

This invention discloses a method for alleviating or treating anaphylaxis, comprising a step of allowing a patient suffering from anaphylaxis to hear drumming.

In some embodiments of the present invention, the drumming is performed with a Buk (a Korean traditional drum).

In some embodiments of the present invention, the drumming has rhythmic cycles of Jajinmori-jangdan or Hwimori-jangdan.

In some embodiments of the present invention, the drumming is a match for the frequency of a baritone voice (139.9 to 355.2 Hz).

In some embodiments of the present invention, the patient suffering from anaphylaxis is allowed to hear the drumming for 5 minutes or more a day in a period of time of 3 weeks or more.

In some embodiments of the present invention, the alleviation or treatment of anaphylaxis is performed by reducing HIF-1α levels in brain of the patient suffering from anaphylaxis.

In some embodiments of the present invention, the alleviation or the treatment of anaphylaxis is performed by reducing VEGF levels in brain or serum of the patient suffering from anaphylaxis.

In some embodiments of the present invention, the alleviation or the treatment of anaphylaxis is performed by reducing IL-1β or TNF-α levels in brain of the patient suffering from anaphylaxis.

In some embodiments of the present invention, the alleviation or the treatment of anaphylaxis is performed by reducing expression of an estrogen receptor-β (ER-β) in brain of the patient suffering from anaphylaxis.

In some embodiments of the present invention, the drumming is alleviating cerebral hypoxia induced by anaphylaxis.

The above objectives and advantages of the present invention will become more readily apparent to those ordinarily skilled in the art after reviewing the following detailed descriptions and accompanying drawings.

### BRIEF DESCRIPTION OF THE DRAWINGS

FIG. 1 is a diagram showing features of Buk.

FIG. 2 is a diagram showing effect of Buk music on compound 48/80-induced systemic anaphylaxis. After mice had been injected with compound 48/80 (6.5 mg/kg), they were exposed to Buk music or white noise for 5 min. Ketotifen was orally administered (1 mg/kg) 1 h before compound 48/80 injection (6.5 mg/kg) injection. (a) Mortality (%) is presented as the number of dead mice 100/total number of experimental mice. (b) Serum histamine was analyzed using a histamine assay. Values are means±SEMs. # p<0.05; significantly different from the normal mice. *p<0.05 significantly different from the compound 48/80 alone. **p<0.05 significantly different from the compound 48/80+white noise. Com 48/80, compound 48/80; Normal, naïve mice.

FIG. 3 is a diagram showing effect of Buk music on HIF-1α levels in brain. (a) HIF-1α protein levels in brain were analyzed by Western blotting. (b) HIF-1α protein levels were quantitated by densitometry. (c) HIF-1α mRNA expressions were assessed by quantitative real-time PCR. Values are means±SEMs. # p<0.05; significantly different from the normal mice. *p<0.05 significantly different from the compound 48/80 alone. **p<0.05 significantly different from the compound 48/80+white noise. Com 48/80, compound 48/80; Normal, naïve mice.

FIG. 4 is a diagram showing effect of Buk music on VEGF levels in serum and brain. (a), (b) VEGF levels in serum and brain were analyzed by ELISA. (c) VEGF mRNA levels in brain were assessed by quantitative real-time PCR. Values are means±SEMs. # p<0.05; significantly different from the normal mice. *p<0.05 significantly different from the compound 48/80 alone. **p<0.05 significantly different from the compound 48/80+white noise. Com 48/80, compound 48/80; Normal, naïve mice.

FIG. 5 is a diagram showing effect of Buk music on inflammatory cytokines levels in brain. Cytokines levels were assessed by ELISA. Values are means±SEMs. # p<0.05; significantly different from the normal mice. *p<0.05 significantly different from the compound 48/80 alone. **p<0.05 significantly different from the compound 48/80+white noise. Com 48/80, compound 48/80; Normal, naïve mice.

FIG. 6 is a diagram showing effect of Buk music on ER-β mRNA levels in brain. ER-β mRNA expression were assessed by quantitative real-time PCR. Values are means±SEMs. # p<0.05; significantly different from the normal mice. *p<0.05 significantly different from the compound 48/80 alone. **p<0.05 significantly different from the compound 48/80+white noise. Com 48/80, compound 48/80; Normal, naïve mice.

### DETAILED DESCRIPTION

The present invention will now be described more specifically with reference to the following embodiments. It is to be noted that the following descriptions of preferred embodiments of this invention are presented herein for purpose of illustration and description only; they are not intended to be exhaustive or to be limited to the precise form disclosed.

In some embodiments of the present invention, the method for the present invention includes a step of allowing patients suffering from anaphylaxis to hear drumming.

Anaphylaxis is a serious allergic reaction that is rapid in onset and may cause death associated with systemic vasodilation and resulting hypotension and hypoxic brain damage.

Drumming is similar to the human heart beat and affects blood pressure, heart rate, and nerve systems.

In some embodiments of the present invention, the drumming may be performed with various kinds of drums, such as Buk, Aburukuwa, Ashiko, Bass drum, Batá, Bedug, Bodhrán, Bongo drums, Bougarabou, Cajón, Candombe drums, Chalice drum, Chenda, Cocktail drum, Conga, Crowdy-crawn, Darbuka, Damphu, Davul, Dayereh, Dhak, Dhimay, Dhol, Dholak, Djembe, Dong Son drum, Doumbek, Dunun, Ewe Drums, Frame drum, Goblet drum, Hand drum, Ilimba drum, Karyenda, Kpanlogo, Lambeg drum, Log, rum, Madal, Mridangam, Repinique, Side drum (Marching snare drum), Slit drum, Snare drum, Steelpan (Steel drum), Surdo, Tabor, Tamborim, Tambourine, Taiko, Tabla, Talking drum, Tapan, Tar, Tavil, Tenor drum, Timbales, Timpani, Tombak, Tom-tom drum and Tongue drum, and preferably the drum may be a Buk.

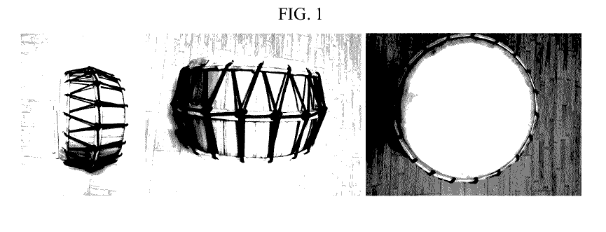

The Buk (FIG. 1) is a Korean traditional drum with a body shaped like a barrel. Its body is normally made of wood such as poplar and paulownia, which produce a deep, hollow, clear sound. The sound of a Buk has been found to help in reduce agitation and may promote relaxation and increase parasympathetic nervous system activity. Its sound can cheer up people who are feeling down, reduce stress, and regulate blood flow, presumably because it is sounds like a heartbeat.

The rhythmic patterns of Buk music use duple division (2) and mixed division (2+3 or 3+2) beats, and just as poems sound musical and resonant, the sound of a Buk has its own musical flowing rhythms and sequences. The sound of a Buk is similar to the human heart beat and affects blood pressure, heart rate, and nerve systems. The sound of a Buk is a match for the frequency of a baritone voice (139.9 to 355.2 Hz). The present inventors found that Buk music (drumming with a buk) reduced anaphylactic reactions in a compound 48/80-induced mouse model and reduced HIF-1α (hypoxia-inducible factor-1α), VEGF (vascular endothelial growth factor), IL-1β (intereukin-1β), TNF-α(tumor necrosis factor-α) levels and expression of an estrogen receptor-β (ER-β) in brain or serum in the mouse model.

The drumming may have rhythmic cycles of Jajinmori-jangdan or Hwimori-jangdan. Each Jajinmori-jangdan and Hwimori-jangdan is one of the jangdans of pansori and sanjo.

The Jajinmori-jangdan consists of four fast beats with three subdivisions in the beats. According to its tempo, the rhythmic cycle can be divided into slow and fast types. It is used to accompany songs describing violent or agitated scenes or moods. The Hwimori-jangdan is the fastest of all music rhythmic cycles, consisting of a rapid 4/4 pattern with duple subdivision of beats, and is used to accompany songs describing urgent scenes or moods.

The term “patient” refers to an animal, preferably a mammal, and most preferably a human, who is the object of treatment, observation or experiment. The mammal may be selected from the group consisting of mice, rats, hamsters, gerbils, rabbits, guinea pigs, dogs, cats, sheep, goats, cows, horses, giraffes, platypuses, primates, such as monkeys, chimpanzees, and apes. In some embodiments, the subject is a human.

HIF-1α, VEGF, IL-1β, TNF-α and ER-β may be independently derived from the patient. In this case, these proteins may have amino acid sequences known in the related art.

A time when the patient suffering from anaphylaxis are allowed to hear drumming with a buk is not particularly limited, and may be properly selected according to a treatment purpose, a condition of a patient, a background, etc. For example, the patients may be allowed to hear the the drumming for 5 minutes or more a day, for example, 5 minutes to 60 minutes, 10 minutes to 60 minutes, 20 minutes to 60 minutes, and 30 minutes to 60 minutes a day.

Such music treatment may be performed for a period of time of one day or several years, for example, one day to a year, one day to 6 months, 10 days to 6 months, 15 days to 60 days, 21 days to 180 days, 21 days to 365 days, according to the conditions of a patient.

### Example

Materials and Methods

Animals

The original stock of male ICR (4 weeks old) was purchased from the Dae-Han Experimental Animal Center (Eumsung, Chungbuk, Republic of Korea). Animal care and experimental procedures used were approved by the Animal Care Committee of Kyung Hee University [KHUASP (SE)-12-019].

Reagents

Avidin peroxidase (AP), bicinchoninic acid (BCA), ketotifen and other reagents were purchased from Sigma (St. Louis, Mo., USA). Anti-mouse VEGF/intereukin-1beta (IL-1β)/tumor necrosis factor-alpha (TNF-α) purified antibody (Ab), anti-mouse VEGF/IL-1β/TNF-α biotin-conjugated Ab, and recombinant mouse (rm) VEGF/IL-1β/TNF-α were purchased from BD Biosciences Pharmingen (San Diego, Calif., USA). Abs for HIF-1α and GAPDH were obtained from Santa Cruz Biotechnology (Santa Cruz, Calif., USA).

Compound 48/80-Induced Systemic Anaphylaxis

Mice were given an intraperitoneal (i.p.) injection of compound 48/80 (6.5 mg/kg). The period used to observe mortality was based on the results of a pretest during which mice died within 30 min of administration. Ketotifen was used as a positive control (1 μg/kg, p.o.). Mortality was monitored for 40 min post-injection. Five mice were allocated to each group and divided into 5 groups; (1) untreated, (2) compound 48/80 injected, (3) compound 48/80 injected and treated with ketotifen, (4) compound 48/80 injected and exposed to Buk music, (5) compound 48/80 injected and exposed to white noise. Three independent experiments were performed (n=15/group).

Music Exposure

Jajinmori-jangdan and Hwimori-jangdan (rhythmic cycles) of Buk music were played by Kyung-Ja Ko. The playing conditions were as follows: Jajinmori-jangdan rhythmic cycle of twelve beats, 4+4+4+4 (12/8 metre, [symbol] =96 to 144), in an allegro moderated tempo and Hwimori-jangdan rhythmic cycle of 4 beats, 2+2 (4/4 metre, [symbol] =208 to 230), in a presto tempo. The sound of a Buk is a match for the frequency of a baritone voice (139.9 to 355.2 Hz). Background sound levels in a special isolation booth were 10 to 40 dB for the compound 48/80 and ketotifen groups and 70 dB for the Buk music and white noise groups. Mice were exposed to Buk music or white noise for 5 min. All experiments were carried out in an environment free of other sounds. Buk music was recorded and copied using a MP3 player to ensure precisely the same music was played for mice in all treatment groups.

Histamine Assay

Histamine content in the serum was measured using the o-phthalaldehyde spectrofluorometric procedure. Fluorescent intensities were measured at 440 nm (excitation at 360 nm) with a spectrofluorometre.

Western Blot Analysis

Western blot analysis was performed on brain tissue extracts, as previously described in (Semenza GL: Hypoxia-inducible factor 1: oxygen homeostasis and disease pathophysiology. Trends Mol Med 2001; 7:345-350).

Quantitative Real-Time PCR

Quantitative real-time PCR was performed using SYBR Green master mix and mRNA levels were analyzed using an ABI StepOne real time PCR System (Applied Biosystems, Foster City, Calif., USA). Primer sequences for the reference gene GAPDH and genes of interest were as follows: GAPDH (5′ TCGACAGTCAGCCGCATCTTCTTT 3′, SEQ ID NO.1; 5′ ACCAAATCCGTT GACTCCGACCTT 3′, SEQ ID NO.2); HIF-1α (5′ GAAGTGGCTTTGGAGTTTCC 3′, SEQ ID NO.3; 5′ CATCTCTCTGGATTTTGGCA 3′, SEQ ID NO.4); VEGF (5′ ACCGCGAGGCAGCTTGAGTT 3′, SEQ ID NO.5; 5′ ACCGCCTTGGCTTGTCACAT 3′, SEQ ID NO.6). Typical profile times used were as follows; initial step 95° C. for 10 min followed by a second step at 95° C. for 15 s and 60° C. for 30 s for 40 cycles. Levels of target mRNAs were normalized versus GAPDH. Data were analyzed using the ΔΔCT method.

Enzyme-Linked Immunosorbent Assay (ELISA)

Cytokines levels in serum and brain were analyzed by ELISA, as described previously [3]. Cytokine levels in brain were divided according to the total protein levels, which were estimated using a BCA protein assay kit (Pierce, Rockford, Ill., USA).

Statistical Analysis

Data are expressed as means±SEMs. The analysis was performed using SPSS ver 11.5. Statistical significance was accepted for p values of <0.05. Treatment effects were analyzed using the independent t-test and one-way analysis of variance (ANOVA), offered by Tukey's multiple range tests.

Results

Effect of Buk Music on Anaphylaxis

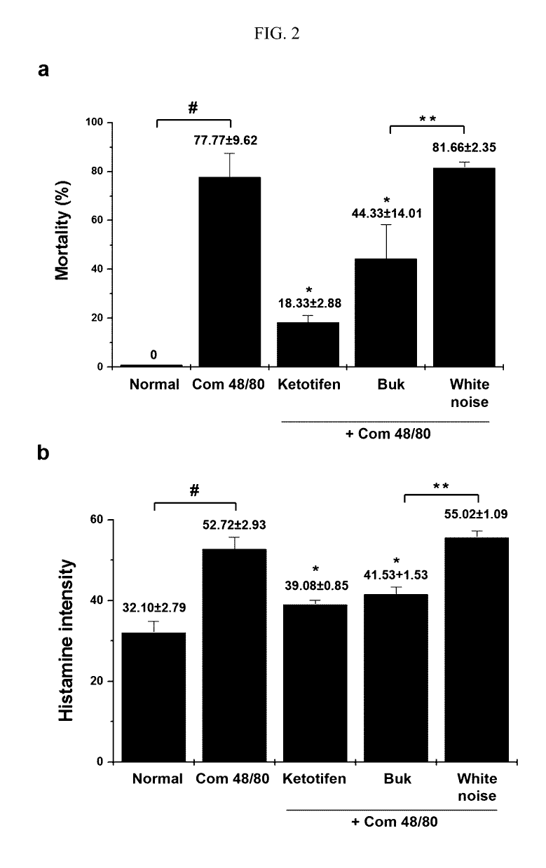

To examine the effects of Buk music on anaphylactic reactions, we used an in vivo model of systemic anaphylaxis. Compound 48/80 (6.5 mg/kg) was used as a systemic fatal anaphylaxis inducer. After injecting compound 48/80 intraperitoneally, mice listened to Buk music for 5 min. As a result, compound 48/80 group induced a fatal reaction about 77%. Exposure to Buk music significantly reduced mortality from compound 48/80 (p<0.05; FIG. 2a). The oral administration of ketotifen also reduced mortality induced by compound 48/80 (p<0.01; FIG. 2a). Anaphylaxis is induced by mast cell degranulation, and to clarify the effect of Buk music on mast cell degranulation, we measured histamine levels in serum. Histamine levels in the compound 48/80 group were significantly higher than in normal group (p<0.05; FIG. 2b). However, histamine levels were significantly lower in the Buk music group than in compound 48/80 group (p<0.05; FIG. 2b). White noise did not affect compound 48/80-induced anaphylaxis (FIG. 2). Buk music also significantly reduced mortality and histamine levels compared with the white noise group (p<0.05; FIG. 2).

Effect of Buk Music on HIF-1α Levels in Brain

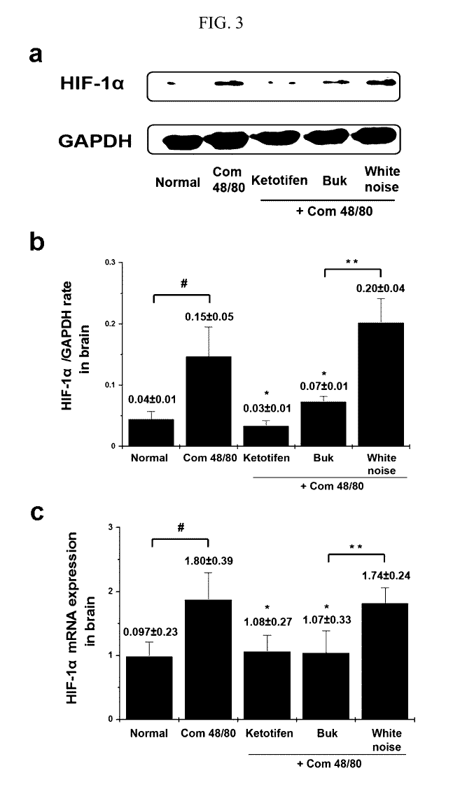

Anaphylactic shock causes brain injury by inducing cerebral hypoxia due to hypoperfusion following hypotension. The hypoxia response system, which is mediated by the transcriptional activator HIF-1α, functions as a key regulator of oxygen homeostasis that facilitates both oxygen delivery and adaptation to oxygen deprivation. Thus, Western blotting was performed to check the expression level of brain HIF-1α in systemic anaphylaxis. It was found that HIF-1α levels were significantly up-regulated in compound 48/80-induced anaphylactic reaction, whereas exposure to Buk music significantly reduced expression of HIF-1α proteins (p<0.05; FIG. 3a, b). To determine whether the induction of HIF-1 mRNA by compound 48/80 activated HIF-1, we performed quantitative real-time PCR. The results showed that HIF-1α mRNA levels were increased in the compound 48/80 group but were significantly lower in the Buk music group (p<0.05; FIG. 3c). Buk music also significantly reduced HIF-1α levels compared with the white noise group (p<0.05; FIG. 3). Oral administration of ketotifen also significantly reduced HIF-1α levels in brain (p<0.05; FIG. 3).

Effect of Buk Music on VEGF Levels in Serum and Brain

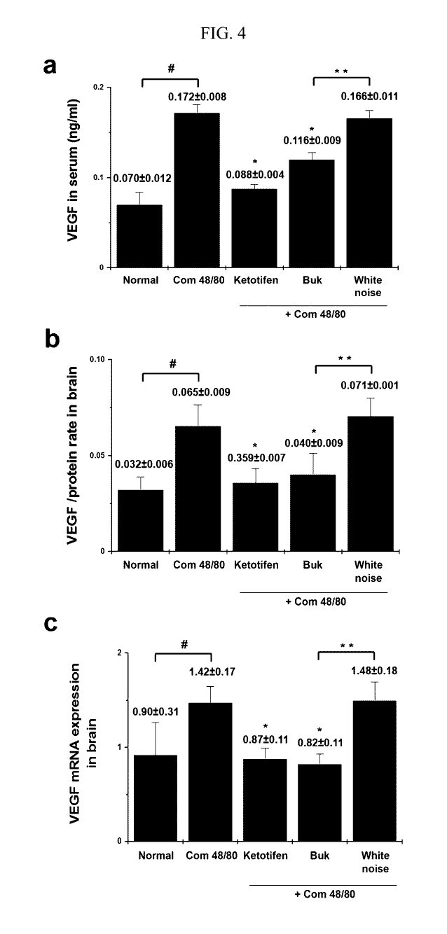

HIF-1α is activated by ischemia and induces VEGF expression, and thus, ELISA was used to check levels of VEGF in serum and brain. Compound 48/80 significantly increased VEGF levels in serum and brain (p<0.05; FIG. 4a, b), but exposure to Buk music significantly reduced these levels (p<0.05; FIG. 4a, b). The brain VEGF mRNA levels were also significantly reduced by exposure to Buk music and by ketotifen (p<0.05; FIG. 4c). Buk music also significantly decreased VEGF levels compared with the white noise group (p<0.05; FIG. 4).

Effect of Buk Music on Inflammatory Cytokines Levels in Brain

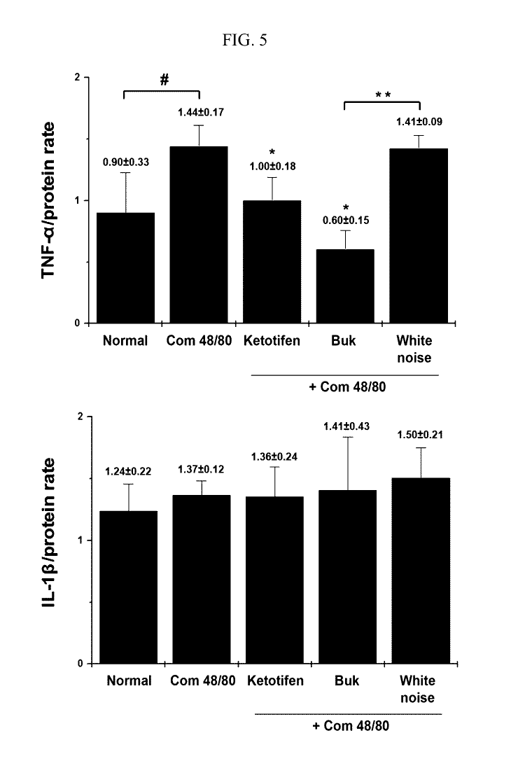

Numerous inflammatory cytokines, such as IL-1, IL-6, IL-8, and TNF-α, have been implicated in the development of allergic inflammatory diseases. Allergic reactions are known to be exacerbated by inflammatory cytokines, and thus, we investigated the effects of Buk music on IL-1β and TNF-α. Our results showed that TNF-α protein levels in brain were increased by anaphylactic reaction but were significantly reduced by exposure to Buk music or ketotifen. Buk music also significantly decreased TNF-α levels compared with the white noise group (p<0.05; FIG. 5). However, Buk music did not change on IL-1β protein levels (p<0.05; FIG. 5).

Effect of Buk Music on ER-β mRNA Levels in Brain

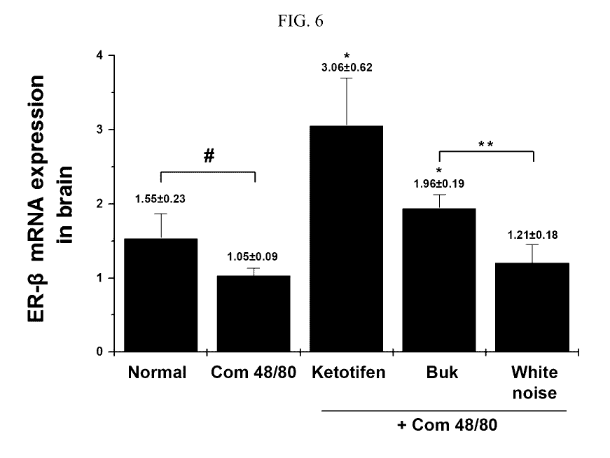

ER-β activation significantly reduces the protein levels of VEGF and of its transcription factor HIF-1α in brain tissues and reduced BBB breakdown. Thus, we examined the regulatory effects of Buk music on ER-β mRNA levels in brain. Compound 48/80 significantly decreased ER-β mRNA levels as compared with normal mice (p<0.05; FIG. 6), whereas Buk music and ketotifen significantly increased ER-β mRNA levels in compound 48/80 administered mice (p<0.05; FIG. 6). Buk music also significantly increased ER-β mRNA levels compared with the white noise group (p<0.05; FIG. 6).

Discussion

Anaphylaxis is an immediate or antibody-mediated hypersensitivity reaction and an unusual exaggerated allergic reaction to allergens, for example, to a foreign protein. Anaphylaxis induces vasodilation, mucous secretion, and bronchoconstriction. The reason for brain injury is considered to be cerebral hypoxia caused by hypotension resulting from anaphylactic shock. Furthermore, these responses decrease adrenergic activity and may produce altered states of consciousness and decreased neuromuscular arousal. It has been shown that the entrainment of body rhythms with music increased physiological excitation and sympathetic nervous system activity.

Our results showed that exposure of compound 48/80 treated to Buk music or ketotifen significantly reduced the mortality, histamine, and HIF-1α, VEGF, and TNF-α levels. In addition, the ER-β mRNA expression reduction induced by compound 48/80 was inhibited by Buk music or ketotifen. These findings indicate that exposure to Buk music inhibited compound 48/80-induced allergic reactions under in vivo conditions.

Severe anaphylaxis is defined based on signs and symptoms of hypotension, hypoxia, and collapse. Compound 48/80 increases the permeability of the lipid bilayer membrane by causing a perturbation in the membrane and induces histamine release from mast cells. Furthermore, hypotension induced by histamine causes hypoxia in brain tissues, and hypoxic environments upregulate HIF-1α responsive chemokines, such as VEGF, which is known to promote the recruitment and proliferation of endothelial progenitor cells, and in addition, the up-regulation of HIF-1 promotes new blood vessel development. Increased vascular permeability is known to induce inflammatory response via VEGF. Rutin exerted anti-allergic effects by suppressing VEGF expression and hypoxia induced histamine synthesis and histidine decarboxylase expression via HIF-1 activation in mast cells. In the present study, Buk music was found to inhibit systemic anaphylaxis and histamine release induced by compound 48/80, and to reduce increases in the levels of HIF-1α and VEGF induced by anaphylaxis. Therefore, we suggest that the anti-allergic effect of Buk music is due to the reduction of brain hypoxia.

HIF-1 is up-regulated by allergic reactions and the expressions of pro-inflammatory cytokines, such as, IL-1β and TNF-α, are increased. Hesperidin reduces the expression of TNF-α by suppressing HIF-1α in mast cells. TNF-α is released from mast cells by degranulation and aggravates allergic symptoms by inducing neutrophil chemotaxis and the productions of other inflammatory cytokines. Our results show that Buk music down-regulated TNF-α protein levels, which suggests Buk music down-regulated TNF-α by the inhibiting HIF-1 activation.

Estrogen has potent neuroprotective effects in animal models of brain disease or injury, and prevents BBB disruption induced by the direct cortical application of recombinant VEGF. ER-β activation contributes to the down-regulations of HIF-1α and VEGF in brain. Furthermore, ER signaling is also involved in the suppression of immune function. Our results show that the down-regulation of ER-β mRNA levels by compound 48/80 were inhibited by exposure to Buk music, indicating Buk music inhibited anaphylaxis by inhibiting the up-regulations of HIF-1α, VEGF, and TNF-α following ER-β activation.

In conclusion, the present inventors shows Buk music reduces compound 48/80-induced mortality and histamine release, and also decreases levels of TNF-α, VEGF, and HIF-1α by activating ER-β. Therefore, we suggest that Buk music be considered a possible therapy for the treatment of allergic disease.

What is claimed is:

1. A method for alleviating or treating anaphylaxis, comprising allowing a patient suffering from anaphylaxis to hear drumming.

2. The method according to claim 1, wherein the drumming is performed with a Buk.

3. The method according to claim 1, wherein the drumming has rhythmic cycles of Jajinmori-jangdan or Hwimori-jangdan.

4. The method according to claim 1, wherein the drumming is a match for the frequency of a baritone voice with a frequency of 139.9 to 355.2 Hz.

5. The method according to claim 1, wherein the patient suffering from anaphylaxis is allowed to hear the drumming for 5 minutes or more a day in a period of time of 3 weeks or more.

6. The method according to claim 1, wherein the alleviation or treatment of anaphylaxis is performed by reducing hypoxia-inducible factor-1 α (HIF-1α) levels in brain of the patient suffering from anaphylaxis.

7. The method according to claim 1, wherein the alleviation or the treatment of anaphylaxis is performed by reducing vascular endothelial growth factor (VEGF) levels in brain or serum of the patient suffering from anaphylaxis.

8. The method according to claim 1, wherein the alleviation or the treatment of anaphylaxis is performed by reducing intereukin-1β (IL-1β) or tumor necrosis factor-α (TNF-α) levels in brain of the patient suffering from anaphylaxis.

9. The method according to claim 1, wherein the alleviation or the treatment of anaphylaxis is performed by reducing expression of an estrogen receptor-β (ER-β) in brain of the patient suffering from anaphylaxis.

10. The method according to claim 1, wherein the drumming is alleviating cerebral hypoxia induced by anaphylaxis.


SEQUENCE LISTING (6 sequences)

SEQ ID NO: 1 - DNA, 24 bp, Artificial Sequence
  primer
tcgacagtcagccgcatcttcttt

SEQ ID NO: 2 - DNA, 24 bp, Artificial Sequence
  primer
accaaatccgttgactccgacctt

SEQ ID NO: 3 - DNA, 20 bp, Artificial Sequence
  primer
gaagtggctttggagtttcc

SEQ ID NO: 4 - DNA, 20 bp, Artificial Sequence
  primer
catctctctggattttggca

SEQ ID NO: 5 - DNA, 20 bp, Artificial Sequence
  primer
accgcgaggcagcttgagtt

SEQ ID NO: 6 - DNA, 20 bp, Artificial Sequence
  primer
accgccttggcttgtcacat